(19) United States
(12) Patent Application Publication
(10) Pub. No.: US 2025/0050635 A1
(43) Pub. Date: Feb. 13, 2025

(54) DRIVE DEVICE AND LIQUID EJECTION DEVICE

(71) Applicant: RISO Technologies Corporation, Tokyo (JP)

(72) Inventors: Yusuke KAJIURA, Numazu Shizuoka (JP); Sota HARADA, Mishima Shizuoka (JP)

(21) Appl. No.: 18/664,132

(22) Filed: May 14, 2024

(30) Foreign Application Priority Data
Aug. 10, 2023 (JP) 2023-131379

(51) Int. Cl. B41J 2/045

(52) U.S. Cl. CPC B41J 2/04588; B41J 2/04541; B41J 2/04581

(57) ABSTRACT

According to one embodiment, a drive device for a liquid ejection device or the like includes a drive circuit configured to output a drive waveform to an actuator of a liquid ejection unit. The actuator has a charge-discharge time constant. The drive waveform during a non-initial portion makes a transition from a first potential higher than an intermediate potential to a second potential lower than the intermediate potential and then a transition from the second potential to the intermediate potential within a time period less than or equal to the charge-discharge time constant.

### CROSS-REFERENCE TO RELATED APPLICATION

This application is based upon and claims the benefit of priority from Japanese Patent Application No. 2023-131379, filed Aug. 10, 2023, the entire contents of which are incorporated herein by reference.

### FIELD

The present disclosure relates to a drive device for a liquid ejection device and a liquid ejection device.

### BACKGROUND

In a liquid ejection device, such as an inkjet head, multi-drop driving in which a voltage is continuously supplied to an actuator during a pulse period equal to the acoustic length (AL) of the device to continuously eject multiple ink droplets to form a single pixel is known. Such driving is referred to as a drive waveform of ejection control. With such a drive waveform, if an amount of outflow and an amount of inflow of a current at an intermediate potential are ill-balanced, current inflow at the intermediate potential occurs in some cases.

In such a liquid ejection device, a technology capable of suppressing the inflow of the current is desired.

### BRIEF DESCRIPTION OF THE DRAWINGS

FIG. 1 depicts a liquid ejection device according to a first embodiment.

FIG. 2 is a perspective view showing a configuration of a liquid ejection head.

FIG. 3 is an equivalent circuit diagram for a channel.

FIG. 4 depicts an escape ejection waveform and a corresponding consumption current of a second power source.

FIG. 5 depicts a reference waveform as a comparative example and a corresponding consumption current of a second power source.

FIG. 6 depicts an escape ejection waveform including a step waveform according to another embodiment and a corresponding consumption current of a second power source.

FIG. 7 depicts a reference waveform including a step waveform as a comparative example and a corresponding consumption current of a second power source.

### DETAILED DESCRIPTION

A problem to be solved by the present disclosure is to provide a drive device and a liquid ejection device capable of suppressing the inflow of the current.

According to one embodiment, a drive device for a liquid ejection device or the like includes a drive circuit configured to output a drive waveform to an actuator of a liquid ejection unit, such as an inkjet head or the like. The actuator has a charge-discharge time constant. The output drive waveform, in a non-initial portion makes, within a time period less than or equal to the charge-discharge time constant, a transition from a first potential higher than an intermediate potential to a second potential lower than the intermediate potential and then a transition from the second potential to the intermediate potential.

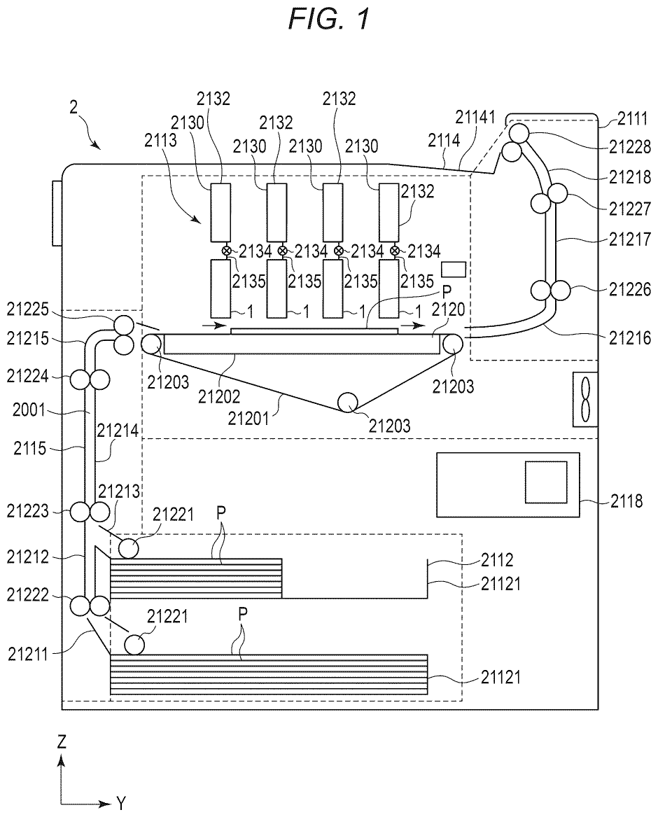

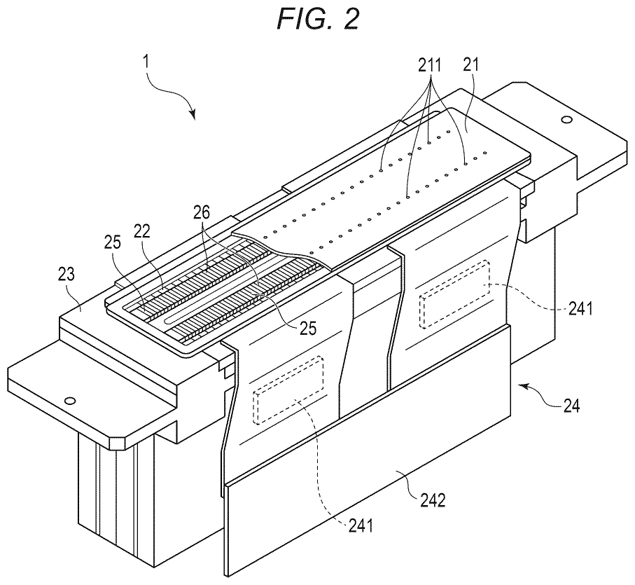

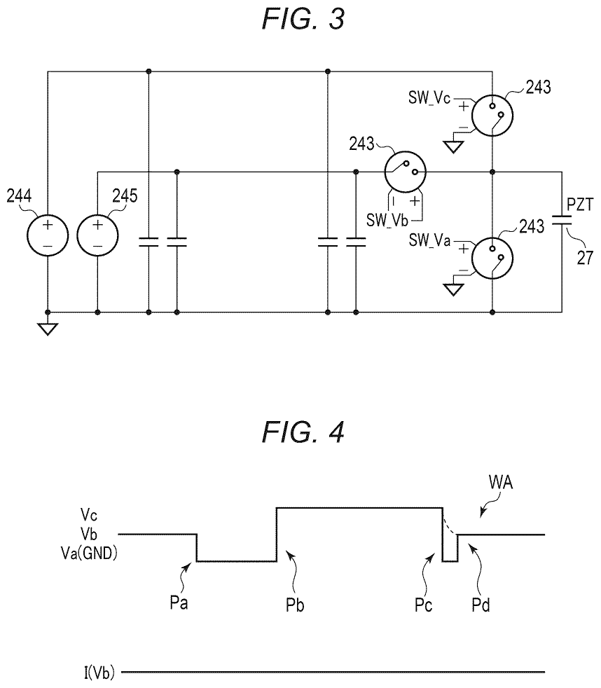

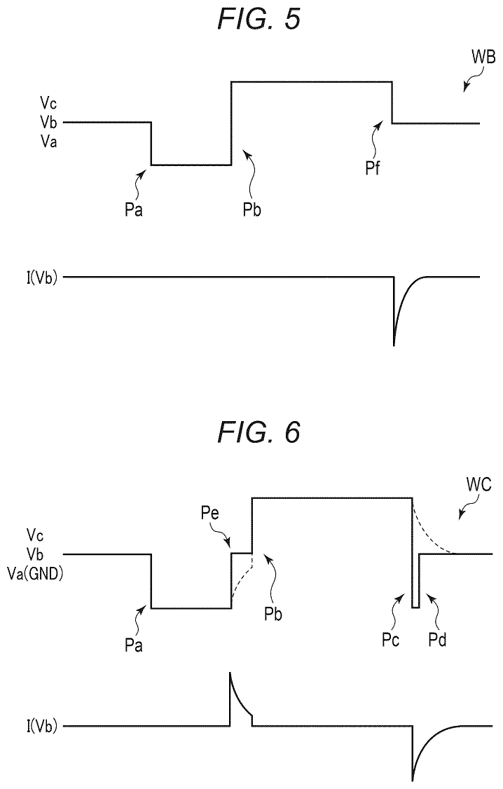

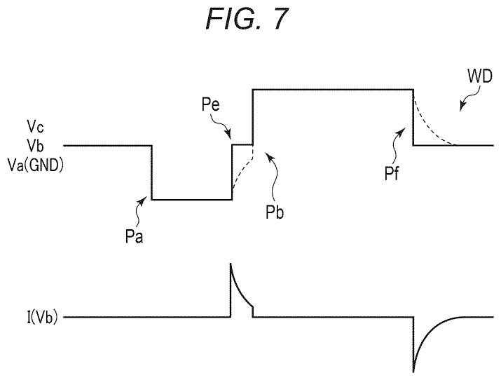

A liquid ejection head 1 and a liquid ejection device 2 incorporating a liquid ejection head 1 according to a first embodiment will hereinafter be described with reference to FIG. 1 and FIG. 2. FIG. 1 depicts the liquid ejection device 2 according to the first embodiment. FIG. 2 is a perspective view showing a configuration of a liquid ejection head 1. FIG. 3 depicts aspects of a drive circuit. FIG. 4 depicts a discharge waveform according to an embodiment and a consumption current of a second power source. FIG. 5 depicts a reference waveform as a comparative example and a consumption current of the second power source. FIG. 6 depicts a discharge waveform including a step waveform Pe according to another embodiment and a consumption current of the second power source. FIG. 7 depicts a reference waveform including a step waveform Pe as a comparative example, and a consumption current of the second power source. It should be noted that aspects depicted in the drawings are not necessarily to scale and various dimension or components may be depicted with expansion or contraction. Additionally, aspects or components may be omitted in some instances as appropriate in the figures for purposes of clarity in explanation.

The liquid ejection device 2 including the liquid ejection head 1 will be described with reference to FIG. 1. The liquid ejection device 2 has a chassis 2111, a medium supply unit 2112, an image forming unit 2113, a medium discharge unit 2114, a conveyance device 2115 (as a medium support device), and a control unit 2118.

The liquid ejection device 2 in this example is an inkjet printer which ejects ink while a sheet P (recording medium or ejection target) is conveyed a predetermined conveyance path 2001 from the medium supply unit 2112 to the medium discharge unit 2114 through the image forming unit 2113 to thereby perform an image forming processing on the sheet P.

The medium supply unit 2112 has a plurality of paper cassettes 21121. The image forming unit 2113 has a support unit 2120 for supporting the sheet during ink ejection processes, and a plurality of head units 2130 disposed above the support unit 2120 so as to be opposed to the support unit 2120. The medium discharge unit 2114 is provided with a catch tray 21141.

The support unit 2120 comprises a conveyance belt 21201 having a loop shape, a support plate 21202 for supporting the conveyance belt 21201 from a reverse side, and a plurality of belt rollers 21203 provided at the reverse side of the conveyance belt 21201.

The head unit 2130 comprises liquid ejection heads 1 as a plurality of inkjet heads, a plurality of supply tanks 2132 respectively mounted on the liquid ejection heads 1, pumps 2134 for supplying the ink from the supply tanks 2132, and coupling flow channels 2135 connecting the liquid ejection heads 1 to the supply tanks 2132.

The liquid ejection head 1 is supplied with the ink from the supply tank 2132. The liquid ejection head 1 may be a noncyclic type head through which ink does not circulate or may be a cyclic type head through which ink circulates (from tank to head and from head to tank).

In the first embodiment, there are liquid ejection heads 1 for four colors, namely cyan, magenta, yellow, and black and corresponding supply tanks 2132 for these four colors. The supply tanks 2132 are respectively coupled to the liquid ejection heads 1 by the coupling flow channels 2135.

As shown in FIG. 2, the liquid ejection head 1 is an inkjet head. The liquid ejection head 1 has a nozzle plate 21 (including a plurality of nozzles 211), an actuator substrate 22, a manifold 23 bonded to the actuator substrate 22, and a drive circuit 24. The drive circuit 24 may also be referred to as a drive waveform generation unit.

The actuator substrate 22 has an actuator unit 25 (a liquid ejection unit) comprising a plurality of pressure chambers 26 (which are disposed so as to be connected to the nozzles 211), and drive elements 27 (individual actuators) for changing the volumes of the pressure chambers 26. The actuator substrate 22 has a predetermined shape for forming flow channels in which the pressure chambers 26 are included in the flow path. The flow channels are formed between the actuator substrate 22 and the nozzle plate 21.

Electrodes to be coupled to the drive circuit 24 are provided on the drive elements 27 adjacent to the pressure chambers 26. The electrodes are coupled to the control unit 2118 by, for example, wiring lines connected to the drive circuit 24 via drivers of the drive circuit 24. The electrodes are configured so that drive control of the electrodes can be achieved under control of a processor or the like.

The drive circuit 24 is provided with a driver IC 241 and a wiring board 242. The drive circuit 24 applies drive voltages to wiring patterns of the actuator unit 25 via the driver IC 241 to thereby drive the actuator unit 25 to increase or decrease the volumes of particular pressure chambers 26 to eject droplets from particular nozzles 211.

The liquid ejection head 1 provides flow channels including the pressure chambers 26 in conjunction with the nozzle plate 21, the actuator substrate 22, and the manifold 23. The flow channels in the liquid ejection head 1 are connected to the coupling flow channels 2135 in the liquid ejection device.

The pumps 2134 are, for example, piezoelectric pumps. The pumps 2134 are connected to the control unit 2118, and controlled by the control unit 2118.

The coupling flow channels 2135 are each provided with a supply flow channel to be coupled to an ink supply tube of the liquid ejection head 1. Further, the coupling flow channels 2135 are each provided with a collection flow channel to be coupled to an ink discharge tube of the liquid ejection head 1. If the liquid ejection head 1 is of a noncyclic type, the collection flow channel is coupled to a maintenance device. If the liquid ejection head 1 is of a cyclic type, the collection flow channel is coupled to the supply tank 2132.

The conveyance device 2115 conveys the sheet P along the conveyance path 2001 from the paper cassette 21121 of the medium supply unit 2112 to the catch tray 21141 of the medium discharge unit 2114. The conveyance path 2001 passes through the image forming unit 2113. The conveyance device 2115 is provided with a guide plate pairs 21211 through 21218 and conveying rollers 21221 through 21228 arranged along the conveyance path 2001. The conveyance device 2115 supports the sheet P so as to move relative to the liquid ejection heads 1.

The control unit 2118 is, for example, a control board (printed circuit board or card). The control unit 2118 includes a processor, a read only memory (ROM), a random access memory (RAM), an I/O port as an input-output port, and an image memory.

The processor is a processing circuit such as a central processing unit (CPU) that can function as a controller. The processor controls the head unit 2130 of the liquid ejection device 2, a drive motor, an input operation unit (e.g., a control panel), a variety of sensors, and the like. The control unit 2118 transmits print data stored in the image memory to the drive circuit 24 in the order necessary for image printing or the like.

Further, the control unit 2118 selects a drive waveform to be used in the image printing. For example, the control unit 2118 selects a waveform to be applied from a set of waveforms incorporating a plurality of stages.

The ROM stores a variety of programs, settings, and the like. The RAM temporarily stores a variety of types of variable data, image data, and the like. The I/O port is an interface unit for data from the outside (e.g., external devices), and also outputs data to the outside (e.g., external devices). The print data from an external device can be transmitted to the control unit 2118 through the I/O port and then stored in the image memory.

The print data is the data which is converted to image data for controlling the ejecting of the liquid (droplets) or the like. The print data may include information such as colors to be printed and image density in each region. The image data is input to the head. The liquid ejection head 1 receives the drive signal corresponding to the print data from the drive circuit 24, and applies a drive waveform to each of the drive elements 27 in the actuator unit 25.

Certain characteristics of a liquid ejection head 1 in a liquid ejection device 2 according to the first embodiment will now be described along with the drive waveform corresponding to the drive signal generated by the drive circuit 24 in the liquid ejection head 1. In this example, the liquid ejection head 1 adopts multi-drop driving. In this multi-drop driving, the drive waveform with a pulse period of an acoustic length(AL) is supplied to the drive elements 27 of the actuator unit 25 to eject a plurality of ink droplets in sequence to form a single pixel. The drive waveform thus combines a plurality of drop waveforms to perform the driving in a plurality of stages. In other words, the drive circuit 24 performs driving with multi-tone (grayscale) drive waveforms using a multi-drop signal of a plurality of patterns (a plurality of types). For example, in the drive waveforms according to the present embodiment, the (pulse) width from the expansion element Pa to the contraction element Pb is set to be the acoustic length (AL), which, in this context, is a time period that is one-half as large as the natural vibration period of the pressure chamber 26 of the liquid ejection head 1.

FIG. 3 is an equivalent circuit diagram of the drive circuit 24 according to the present embodiment. The drive circuit 24 is capable of switching between three or more voltages, and corresponds to a drive waveform generation unit which switches between the three or more voltages to thereby output predetermined drive waveforms. As an example, as shown in FIG. 3, the drive circuit 24 can be provided with three switches 243 coupled to the drive element 27 and two power sources 244, 245. The drive circuit changes (switches) the voltages applied to the drive element 27 by switching the switches 243 to output drive waveforms including three or more voltage values.

The control unit 2118 sets the drive waveforms to be applied to the drive elements 27 based on the print data. For example, the control unit 2118 switches the coupling of the power sources 244, 245 and ground (GND) by selectively switching the switches 243 to switch the voltage value applied to the drive element 27 between the three or more levels of voltages. In other words, the drive circuit 24 switches the switches 243 to function as a drive waveform generation unit that generates and outputs predetermined drive waveforms.

In the present example, the switching of the voltage is between three different potentials, namely a first potential when coupled to the first power source 244, an intermediate potential when coupled to the second power source 245, and a second potential when coupled to the ground.

Here, the intermediate potential Vb can be any potential between the lowest potential and the highest potential. In this example, the second potential Va (corresponding to a discharge potential) is set to the ground potential (GND). Specifically, in the present embodiment, the first potential Vc is set to the highest potential, the second potential Va is set to the lowest potential (here, ground potential), and the intermediate potential Vb is set to a potential in between first potential Vc and second potential Va).

For example, the control unit 2118 outputs an ejection waveform WA (see FIG. 4), which is obtained by temporarily dropping the waveform voltage to the second potential Va when changing the waveform voltage from the first potential Vc to the intermediate potential Vb or vice versa. The ejection waveform WA can be supplied to any of the drive elements 27.

FIG. 4 is a graph showing the ejection waveform WA, wherein the vertical axis for the upper portion (waveform portion) represents voltage (V), and the horizontal axis represents time (μs). Here, the ejection waveform WA is an ejection waveform for ejecting liquid once from a nozzle 211 by expansion and contraction. The ejection waveform WA represents a drop waveform (droplet waveform) corresponding to a single droplet in a multi-drop driving scheme. In other words, the ejection waveform WA can be provided as a single droplet waveform in a multi-drop waveform including a plurality of drop waveforms in a sequence.

As shown in FIG. 4, the ejection waveform WA first makes the transition from the intermediate potential Vb to the second potential Va, and then makes the transition from the second potential Va to the first potential Vc. The transition from the first potential Vc to the second potential Va is then made, followed by the transition from the second potential Va to the intermediate potential Vb. Such changes are made in a time period equal to or shorter than the charge-discharge time constant of the actuator.

Specifically, the ejection waveform WA is a drive waveform including the expansion element Pa which first drops the voltage from the intermediate potential Vb to the second potential Va to expand the pressure chamber, the contraction element Pb which, after a certain time elapses, raises the voltage from the second potential Va to the first potential Vc to contract the pressure chamber, an escape element Pc which drops the voltage from the first potential Vc to the second potential Va at a predetermined timing after the contraction to release current, and a restoration element Pd which restores the voltage from the second potential Va to the intermediate potential Vb within a time period equal to or shorter than the charge-discharge time constant after the dropping of the voltage to the second potential Va.

Here, the time period for which the voltage is dropped to the second potential Va is set to a time period equal to or shorter than the charge-discharge time constant of the drive element 27 (the actuator) to be driven (the drive target).

Specifically, the control unit 2118 performs the switching to the second potential Va (GND) (lower than the second power source 245) when performing the switching from the first power source 244 to the second power source 245 to temporarily release the current inflow to the second power source 245 to GND in the drive circuit 24. Then, the switching to the second power source 245 is performed again within a time period equal to or shorter than the charge-discharge time constant to thereby restore the intermediate potential Vb.

The lower portion in FIG. 4 is a graph representing the consumption current I(Vb) of the second power source 245 during the driving by the ejection waveform WA. According to FIG. 4, for the ejection waveform WA, the consumption current I(Vb) does not drop even when restoring the intermediate potential Vb after the contraction. The consumption current I(Vb) exhibits a straight line, keeping a constant current value. In other words, no inflow of the charge occurs.

According to the present embodiment, it is possible to provide a drive device and a liquid ejection device capable of suppressing the current inflow. In other words, by temporarily dropping the voltage to the second potential Va when changing the voltage from the first potential Vc to the intermediate potential Vb after the contraction element Pb, it is possible to prevent the charge in the drive element 27 from inflowing into the second power source 245.

FIG. 5 is an explanatory diagram showing a comparative example that is a reference waveform WB and the current consumption current I(Vb) of the second power source 245. The reference waveform WB includes the expansion element Pa which changes the voltage from the intermediate potential Vb to the second potential Va, the contraction element Pb which, after a certain time elapses, raises the voltage from the second potential Va to the first potential Vc to contract the pressure chamber, and a restoration element Pf which restores the voltage from the first potential Vc to the intermediate potential Vb at a predetermined timing after the contraction. The consumption current I(Vb) of the second power source 245 for this reference waveform WB is a straight line at a reference current value until when the restoring to the intermediate potential Vb after the contraction occurs, at which point, consumption current I(Vb) abruptly drops when the intermediate potential Vb is restored, and then more gradually returns to the reference current value after the drop point as a curve. In other words, it is represented that the consumption current I(Vb) of the second power source 245 drops when restoring to the intermediate potential Vb. When performing switching from the first power source 244 to the second power source 245, the charge in the drive element 27 inflows into the second power source 245.

In contrast, in the ejection waveform WA as shown in FIG. 4, the outflow of the charge from the drive element 27 is successfully prevented by temporarily setting the drive waveform to the low potential level (Va) to thereby permit discharge.

Furthermore, in the ejection waveform WA, by making the time period in which the voltage is set to the second potential Va equal to or shorter than the charge-discharge time constant of the actuator, it is possible to avoid an increase in power consumption and influence on the drive waveform. Specifically, the discharge time may also depend on the voltage level, a capacitance of the material (e.g., lead zirconate titanate (PZT)) of the drive element 27, and so on, and if the discharge time is set to be too short, some inflow into the second power source may occur. If the discharge time is set to be too long, the current outflows from the second power source 245 start to become a factor that may increase the consumption current of the second power source 245. Therefore, it is necessary to set the discharge time to an appropriate time. By adjusting the discharge time to be shorter than or equal to the charge-discharge time constant, it is possible to prevent the inflow from the power source and avoid influence on the printing quality.

It should be noted that the embodiment is not limited to the configuration described above, but can be implemented with modifications as appropriate.

For example, the drive waveform that is used is not limited to the example described above, and can be modified as appropriate. FIG. 6 is a graph showing an ejection waveform WC including a step waveform Pe and the escape element Pc.

As shown in FIG. 6, the ejection waveform WC includes the expansion element Pa which drops the voltage from the intermediate potential Vb to the second potential Va to expand the pressure chamber, the contraction element Pb including the step waveform Pe which restores the intermediate potential Vb from the second potential Va after a certain time elapses, and further raises the voltage from the intermediate potential Vb to the first potential Vc to contract the pressure chamber 26, the escape element Pc which drops the voltage from the first potential Vc to the second potential Va, and the restoration element Pd which restores the voltage from the second potential Va to the intermediate potential Vb.

The consumption current I(Vb) of the second power source 245 with this ejection waveform WC is a straight line at the reference current value until the restoring to the intermediate potential Vb during the expansion, then abruptly rises when restoring the intermediate potential Vb after the expansion, and then gradually returns to the reference current value after the rising peak as a curve. Later, the consumption current I(Vb) of the second power source 245 is a straight line at the reference current value until the restoring of the intermediate potential Vb after the contraction. The consumption current I(Vb) then abruptly drops when restoring to the intermediate potential Vb, and then gradually returns to the reference current value from the drop point as a curve. In the ejection waveform WC, the amount of rise in consumption current I(Vb) when restoring the intermediate potential Vb after the expansion and the amount of drop when restoring the intermediate potential Vb are comparable to each other. In other words, the escape element Pc can be set to match (or substantially so) the inflow of the charge experienced in the previous step element so as to cancel out the inflow of the charge. For example, the condition of the escape element Pc is set to so the sum of the inflow current for the whole of the ejection waveform WC is zero (or substantially so).

Specifically, the waveform WC makes the transition from the intermediate potential Vb to the second potential Va, and then makes the transition to the first potential Vc from the second potential Va by passing through the step waveform Pe, which holds the voltage at the intermediate potential Vb for a predetermined time period. Since the charge outflows in this step waveform Pe, the discharge with the subsequent escape element Pc (which sets the voltage to the second potential Va for the time period equal to or shorter than the charge-discharge time constant of the actuator), the amount of the discharge and the amount of the charge in the step waveform Pe can be set to be close to each other or the same as each other to thereby make them cancel each other out. In other words, by generating the inflow of charge setting the discharge by the escape ejection waveform to match the outflow of the charge, it is possible for the waveform WC to have the inflow and the outflow of the charge cancel each other out between the step waveform Pe and the escape ejection waveform.

By temporarily dropping the voltage to the second potential Va to perform the discharge when changing the voltage from the first potential Vc to the intermediate potential Vb after the contraction element Pb, it is possible to prevent the charge in the drive element 27 from inflowing into the second power source 245.

FIG. 7 shows a reference ejection waveform WD including the step waveform Pe as a comparative example. The ejection waveform WD includes the expansion element Pa which drops the voltage from the intermediate potential Vb to the second potential Va, the contraction element Pb which restores the intermediate potential Vb from the second potential Va after a certain time elapses, and then raises the voltage from the intermediate potential Vb to the first potential Vc to contract the pressure chamber at a predetermined timing, and a restoration element Pf which returns the voltage from the first potential Vc to the intermediate potential Vb at a predetermined timing after the contraction.

In other words, there is provided the step waveform Pe which keeps the voltage at the intermediate potential Vb, and the raises the voltage in a stepwise manner when performing the contraction. The consumption current I(Vb) of the second power source 245 in the driving with the reference waveform WD including this step waveform Pe is a straight line at the reference current value until the restoring of the intermediate potential Vb during the expansion. The current consumption I(Vb) rises at the restoring of the intermediate potential Vb after the expansion, and then gradually returns to the reference current value after the rising point as a curve. Subsequently, the consumption current I(Vb) of the second power source 245 is again a straight line at the reference current value until the restoring of the intermediate potential Vb after the contraction, then drops when restoring the intermediate potential I(Vb), and then gradually returns to the reference current value from the drop point as a curve. In other words, in the ejection waveform WD including the step waveform, the consumption current I(Vb) of the second power source 245 drops when restoring to the intermediate potential Vb, which represents that the charge inflows into the second power source 245 from the drive element 27. In the ejection waveform WD, by adopting the step waveform which raises the voltage to the intermediate potential Vb in a stepwise manner and then increases the voltage to the first potential Vc from the second potential Va, it is possible to prevent the inflow to the second power source. However, if the step time is not sufficient, sufficient discharge cannot be achieved. If the step time is too long, the printing quality is affected.

In the ejection waveform WC, the drop of the consumption current I(Vb) when restoring the intermediate potential Vb is further suppressed as compared to the ejection waveform WD. Further, the amount of the drop is comparable with the amount of the rise in the step waveform Pe, and therefore, the charge in the step waveform Pe and the discharge in the escape element Pc can cancel each other out.

Furthermore, in the ejection waveform WC, by making the time period for which the voltage is set to the second potential Va equal to or shorter than the charge-discharge time constant of the actuator, it is possible to avoid an increase in power consumption and an influence on the drive waveform. In other words, since the inflow from the power source when the discharge time is too long, by making the discharge time equal to or shorter than the time constant, it is possible to prevent the inflow from the power source.

In an embodiment, the drive circuit 24 including the driver IC 241 provided in the liquid ejection head 1 is illustrated as an example of a drive device, but examples are not limited to this. It is possible to adopt a variety of control devices to function as a drive device. For example, an external control device may be coupled to the liquid ejection head 1.

It is possible to combine a plurality of types of waveforms with each other instead use a single type waveform. For example, it can be sufficient to include an escape element in any drive waveform to be applied at any timing to any of the plurality of drive elements 27, and it is possible to drive a drive element 27 with the drive waveform in combination with different waveforms. For example, the ejection waveform including the escape element may be a part of the multi-drop waveform which ejects multiple droplets using a plurality of ejection waveforms or may be a single waveform which ejects a droplet with a one-time (single droplet) ejection waveform.

Regarding voltages, the example embodiments described above are not limitations. For example, the discharge potential functioning as the second potential Va is not limited to being the ground potential (GND).

Furthermore, the described example has the first potential Vc and the second potential Va respectively set to the highest voltage and the lowest voltage, but this is not a limitation, and it is possible to set these potentials to other or opposite voltage values.

The switching being performed between three potentials is not a limitation, and it is possible to adopt a configuration in which the switching may be performed between four or more potentials.

It is possible to include a non-ejection waveform (which does not eject liquid) in the driving.

The configuration of the liquid ejection head 1 is not limited to the example described above, and a head of other types can be adopted. For example, the liquid ejection head may have a configuration in which a vibrating plate is disposed between the pressure chamber and the drive element. The vibrating plate may be vibrated by the deformation of the drive element to thereby drive the liquid ejection unit.

According to at least one of the embodiments described hereinabove, it is possible to provide the drive device and the liquid ejection device capable of suppressing the current inflow.

While certain embodiments of the present disclosure have been described, the embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. These embodiments and modifications fall within the scope and spirit of the disclosure and fall within the disclosure described in the claims and their equivalents

What is claimed is:

1. A drive device, comprising:
a drive circuit configured to output a drive waveform to an actuator of a liquid ejection unit, wherein
the actuator has a charge-discharge time constant, and
the drive waveform in a non-initial portion makes, within a time period less than or equal to the charge-discharge time constant, a transition from a first potential higher than an intermediate potential to a second potential lower than the intermediate potential and then a transition from the second potential to the intermediate potential.

2. The drive device according to claim 1, wherein the drive circuit is configured to switch between three voltages for outputting the drive waveform.

3. The drive device according to claim 1, wherein the drive waveform in an initial portion before the non-initial portion makes a transition from the intermediate potential to the second potential, and then a transition from the second potential to the first potential.

4. The drive device according to claim 3, wherein, in the initial portion of the waveform, the transition from the second potential to the first potential occurs in a step waveform in which the intermediate potential is held for a predetermined time period before transitioning to the first potential.

5. The drive device according to claim 4, wherein the time period for the non-initial portion of the waveform is set to compensate for an amount of charge accumulated due to the step waveform.

6. The drive device according to claim 1, wherein the intermediate potential is ground potential.

7. The drive device according to claim 1, wherein the liquid ejection unit is a inkjet head.

8. The drive device according to claim 1, wherein the drive circuit includes two voltage sources and three switches.

9. The drive device according to claim 1, wherein the actuator is a piezoelectric actuator.

10. A liquid ejection device, comprising:
a liquid ejection head including an actuator; and
a drive device including a drive circuit, the drive circuit configured to output a drive waveform to the actuator, wherein
the actuator has a charge-discharge time constant, and
the drive waveform in a non-initial portion makes, within a time period less than or equal to the charge-discharge time constant, a transition from a first potential higher than an intermediate potential to a second potential lower than the intermediate potential and then a transition from the second potential to the intermediate potential.

11. The liquid ejection device according to claim 10, wherein the drive circuit is configured to switch between three voltages for outputting the drive waveform.

12. The liquid ejection device according to claim 10, wherein the drive waveform in an initial portion before the non-initial portion makes a transition from the intermediate potential to the second potential, and then a transition from the second potential to the first potential.

13. The liquid ejection device according to claim 12, wherein, in the initial portion of the waveform, the transition from the second potential to the first potential occurs in a step waveform in which the intermediate potential is held for a predetermined time period before transitioning to the first potential.

14. The liquid ejection device according to claim 13, wherein the time period for the non-initial portion of the waveform is set to compensate for an amount of charge accumulated due to the step waveform.

15. The liquid ejection device according to claim 10, wherein the intermediate potential is ground potential.

16. The liquid ejection device according to claim 10, wherein the liquid ejection head is a inkjet head.

17. The liquid ejection device according to claim 10, wherein the drive circuit includes two voltage sources and three switches.

18. The liquid ejection device according to claim 10, wherein the actuator is a piezoelectric actuator.

19. A printer, comprising:
a sheet conveying apparatus;
an inkjet head including an actuator and configured to eject ink towards a sheet conveyed by the sheet conveying apparatus; and
a drive device including a drive circuit, the drive circuit configured to output a drive waveform to the actuator, wherein
the actuator has a charge-discharge time constant, and
the drive waveform in a non-initial portion makes, within a time period less than or equal to the charge-discharge time constant, a transition from a first potential higher than an intermediate potential to a second potential lower than the intermediate potential and then a transition from the second potential to the intermediate potential.

20. The printer according to claim 19, wherein, in the initial portion of the waveform, the transition from the second potential to the first potential occurs in a step waveform in which the intermediate potential is held for a predetermined time period before transitioning to the first potential.
